(19) United States
(12) Patent Application Publication
(10) Pub. No.: US 2022/0317410 A1
(43) Pub. Date: Oct. 6, 2022

(54) LENS ASSEMBLY

(71) Applicant: SAMSUNG ELECTRO-MECHANICS CO., LTD., Suwon-si (KR)

(72) Inventors: So Mi YANG, Suwon-si (KR); Jae Hyuk HUH, Suwon-si (KR); You Jin JEONG, Suwon-si (KR); Ji Su LEE, Suwon-si (KR)

(73) Assignee: SAMSUNG ELECTRO-MECHANICS CO., LTD., Suwon-si (KR)

(21) Appl. No.: 17/369,655

(22) Filed: Jul. 7, 2021

(30) Foreign Application Priority Data
Apr. 6, 2021 (KR) 10-2021-0044706

(51) Int. Cl. G02B 7/02; G02B 7/00

(52) U.S. Cl. CPC G02B 7/021; G02B 7/026; G02B 7/003

(57) ABSTRACT

A lens assembly includes: a first lens including a protrusion; and a second lens disposed adjacent to the first lens and including a recess configured to accommodate at least a portion of the protrusion. The protrusion is spaced apart from the recess in an optical axis direction.

### CROSS-REFERENCE TO RELATED APPLICATIONS

This application claims the benefit under 35 U.S.C. § 119(a) of Korean Patent Application No. 10-2021-0044706 filed on Apr. 6, 2021 in the Korean Intellectual Property Office, the entire disclosure of which is incorporated herein by reference for all purposes.

### BACKGROUND

### 1. Field

The following description relates to a lens assembly.

### 2. Description of Related Art

Recently, various types of lenses have been developed for the purpose of increasing resolution or applying a high magnification. Examples of such lenses may include a D-cut lens or a free-form lens. The free-form lens and the D-cut lens are non-axisymmetric and thus may have a difference in performance depending on an alignment position with other optical elements (e.g., other lenses, light blocking members, etc.). For example, even when the free-form lens is aligned with a adjacent lens on an optical axis, if the two lenses are assembled in a state of deviating in a circumferential direction with respect to the optical axis, resolution of the optical system may be degraded.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens assembly includes: a first lens including a protrusion; and a second lens disposed adjacent to the first lens and including a recess configured to accommodate at least a portion of the protrusion. The protrusion is spaced apart from the recess in an optical axis direction.

The lens assembly may further include a lens barrel configured to align the first lens in a direction perpendicular to an optical axis with respect to the second lens. The protrusion and the recess may be configured to limit rotation of the first lens about the optical axis with respect to the second lens.

The protrusion and the recess may be spaced apart from each other in a direction perpendicular to the optical axis.

The lens assembly may further include a spacer disposed between the first lens and the second lens.

The protrusion and the recess may be disposed in respective portions facing the spacer in the optical axis direction.

The spacer may include a through portion configured to allow the protrusion to pass therethrough.

The first lens may include a first optical portion exhibiting optical performance, and a first flange surface surrounding an outer circumference of the first optical portion and contacting the spacer. The protrusion may extend from the first flange surface toward the second lens.

The second lens may include a second optical portion exhibiting optical performance and a second flange surface surrounding an outer circumference of the second optical portion and contacting the spacer. The recess may include a depressed portion of the second flange surface.

A depth by which the recess is depressed from the second flange surface may be greater than a length obtained by subtracting a thickness of the spacer from a height at which the protrusion protrudes from the first flange surface.

The first lens may be non-axisymmetric with respect to an optical axis.

The first lens may be a D-cut lens.

The lens assembly may further include: a lens barrel accommodating the first lens and the second lens. The first lens includes a linear portion and an arc portion, and the lens barrel may be configured to surround at least a portion of the arc portion and to expose the linear portion in a direction perpendicular to the optical axis.

The lens barrel may include an open portion exposing the linear portion. The linear portion may extend in a first direction perpendicular to the optical axis. The open portion may expose the linear portion in a second direction perpendicular to both the optical axis and the first direction.

The first lens may be a free-form lens.

In another general aspect, a lens assembly includes: a first lens; a second lens adjacent to the first lens; and an alignment structure aligning the first lens and the second lens in a circumferential direction with respect to an optical axis. The alignment structure may be configured to allow the first lens to move with respect to the second lens in a direction perpendicular to an optical axis.

The alignment structure may include a protrusion disposed on the first lens and a recess disposed in the second lens. An air gap may be disposed between the protrusion and the recess.

In another general aspect, a lens assembly includes: a first lens disposed on an optical axis; one or more protrusions protruding from a surface of the first lens, in a direction parallel to the optical axis; a second lens disposed on the optical axis; and one or more recesses disposed on a surface of the second lens opposing the surface of the first lens in the direction parallel to the optical axis. The one or more protrusions extend only partially into the one or more recesses, respectively, in the direction parallel to the optical axis.

The one or more protrusions may be disposed on a flange of the first lens, and the one or more recesses may be disposed on a flange of the second lens.

The lens assembly may further include a spacer disposed between the first lens and the second lens in the direction parallel to the optical axis. The spacer may include one or more openings elongated in a direction perpendicular to the optical axis and configured to receive the one or more protrusions, respectively.

Each of the one or more protrusions may be configured to be spaced apart from a wall defining a respective opening, among the one or more openings, in either one or both of a radial direction with respect to the optical axis and a circumferential direction with respect to the optical axis.

Other features and aspects will be apparent from the following detailed description, the drawings, and the claims.

### BRIEF DESCRIPTION OF DRAWINGS

FIG. 1 is a cross-sectional view of a lens assembly, according to an embodiment.

FIG. 2 is a diagram illustrating two adjacent D-cut lenses, in an embodiment.

FIG. 3 is an exploded view of FIG. 2.

FIG. 4 is a cross-sectional view taken along line I-I′ of FIG. 2.

FIG. 5 is a view of a protrusion and a recess in a direction parallel to an optical axis, in an embodiment;

FIG. 6 is another example of a protrusion provided in a lens.

FIG. 7 is another example of a recess provided in a lens.

FIGS. 8 through 10 illustrate spacers, according to embodiments.

FIG. 11 is a perspective view of the lens assembly of FIG. 1, according to an embodiment.

FIG. 12 is a cross-sectional view taken along line II-II′ of FIG. 11.

FIG. 13 illustrates an alignment structure between adjacent circular lenses, in an embodiment.

Throughout the drawings and the detailed description, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The features of the examples described herein may be combined in various ways as will be apparent after an understanding of this disclosure. Further, although the examples described herein have a variety of configurations, other configurations are possible as will be apparent after an understanding of this disclosure.

Herein, it is noted that use of the term “may” with respect to an example, for example, as to what an example may include or implement, means that at least one example exists in which such a feature is included or implemented while all examples are not limited thereto.

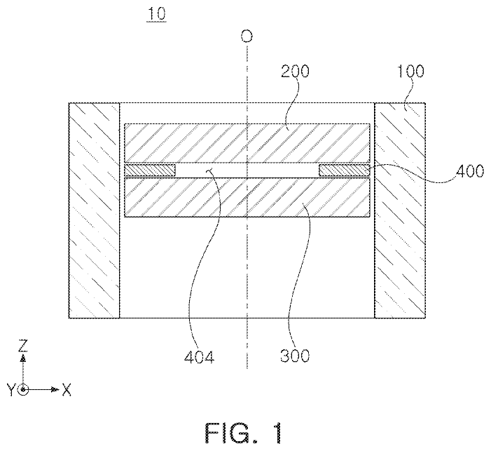

FIG. 1 is a cross-sectional view of a lens assembly 10, according to an embodiment.

Referring to FIG. 1, the lens assembly 10 may include a lens barrel 100, and a first lens 200 and a second lens 300 accommodated in the lens barrel 100. In the illustrated embodiment, only two lenses 200 and 300 are shown inside the lens barrel 100, but this configuration is only for convenience of explanation. One or more additional lenses, in addition to the first and second lenses 200 and 300, may be disposed in the lens barrel 100.

In an embodiment, the lens assembly 10 may include a spacer 400 disposed between the first lens 200 and the second lens 300. The spacer 400 may include a hole 404 through which light passes.

The spacer 400 may be configured to separate the first lens 200 and the second lens 300 at a specified interval. That is, the first lens 200 and the second lens 300 may be spaced apart from each other at a predetermined interval through the spacer 400. For example, the spacer 400 may be manufactured so that a distance between the first lens 200 and the second lens 300 has a prescribed value.

The spacer 400 may function as a light blocking member blocking a portion of light passing through the first lens 200. In this case, the spacer 400 may contribute to preventing a flare phenomenon.

The lens assembly 10 illustrated in FIG. 1 schematically illustrates the components of the lens assembly 10 for convenience of description, and embodiments of the disclosure herein are not limited thereto.

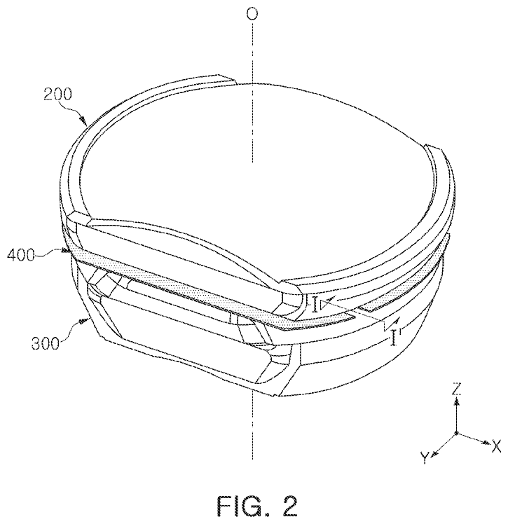

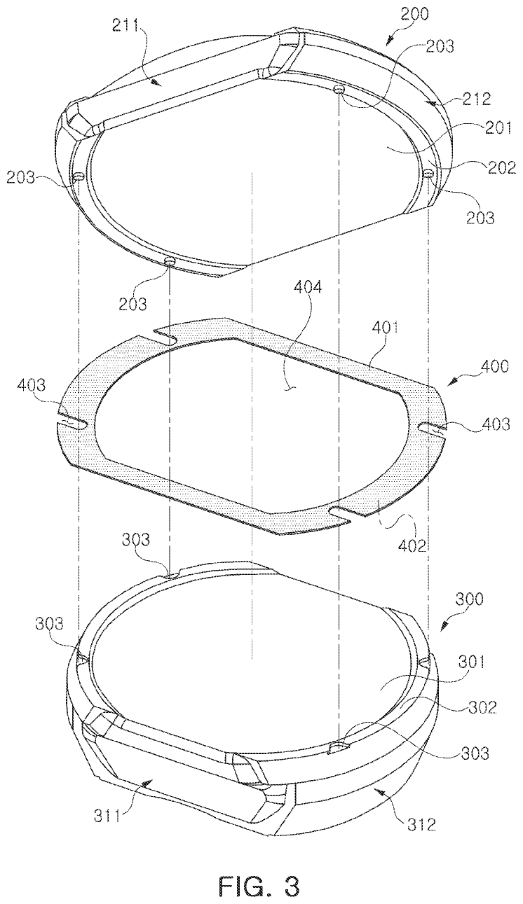

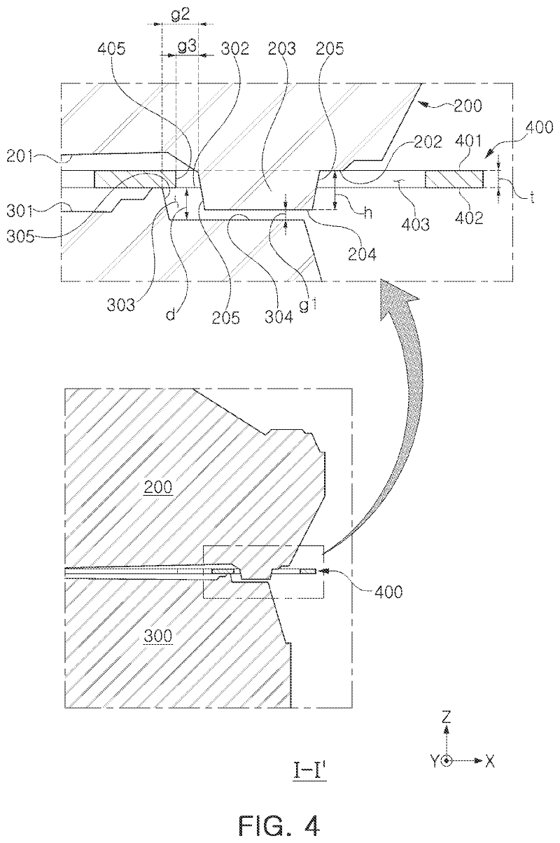

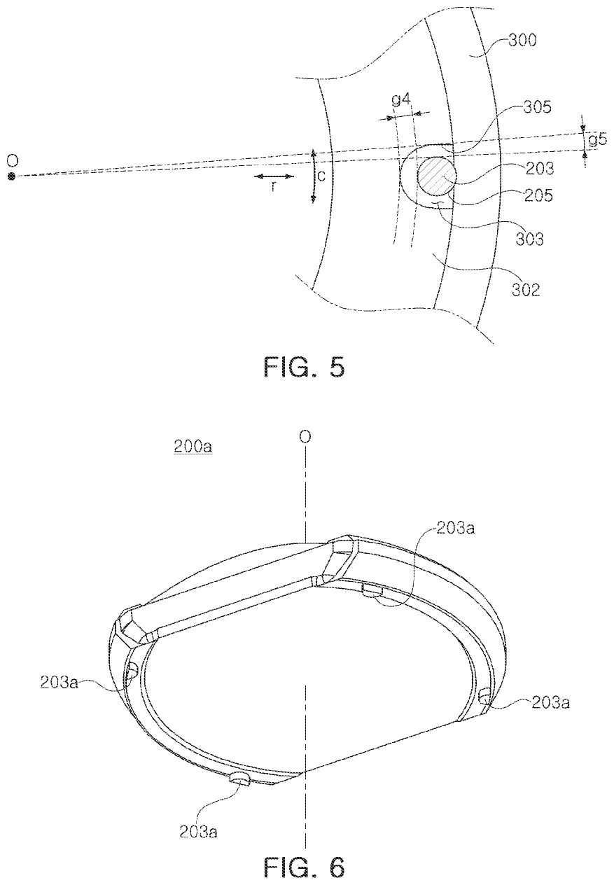

FIG. 2 illustrates an example shape of the first lens 200, the second lens 300, and the spacer 400 accommodated in the lens barrel 100 of FIG. 1. FIG. 3 is an exploded view of FIG. 2. FIG. 4 is a cross-sectional view taken along line I-I of FIG. 2. FIG. 5 is a view of a protrusion 203 and a recess 303 in a direction parallel to an optical axis O, in an embodiment.

In an embodiment, the first lens 200 and/or the second lens 300 may be non-axisymmetric with respect to the optical axis O. For example, the first lens 200 and the second lens 300 may be D-cut lenses, as illustrated in FIG. 2. The D-cut lenses may have a shape in which edges of a circular lens are cut out in a straight line.

A side surface of the first lens 200 may include a linear portion 211 and an arc portion 212. The linear portion 211 is a portion extending in a direction perpendicular to the optical axis O on the side surface. The arc portion 212 is a portion extending in the circumferential direction on the side surface based on the optical axis O. The linear portion 211 may include two linear portions extending parallel to each other. For example, the two linear portions of the linear portion 211 may be spaced apart from each other in the Y direction may extend parallel to each other in the X direction. The arc portion 212 may include two arc portions facing each other. For example, the two arc portions of the arc portion 212 may be spaced apart from each other in the X direction.

The side surface of the second lens 300 may include a linear portion 311 and an arc portion 312. The linear portion 311 is a portion extending in a direction perpendicular to the optical axis O from the side. The arc part 312 is a part extending in the circumferential direction around the optical axis O from the side. The linear portion 311 may include two linear portions extending parallel to each other. For example, two linear portions of the linear portion 311 may be spaced apart from each other in the Y direction may extend parallel to each other in the X direction. The arc portion 312 may include two arc portions facing each other. For example, the two arc portions of the arc portion 312 may be spaced apart from each other in the X direction.

In this disclosure, a shape of each of the D-cut lenses may be defined by a shorter axis length and a longer axis length. Referring to FIG. 2, a direction in which two linear portions face each other is a shorter axis direction, and a direction in which the two arc portions face each other is a longer axis direction. For example, the shorter axis length may refer to a width of the D-cut lens in the Y direction, and the longer axis length may refer to a width of the D-cut lens in the X direction. The shorter axis length may correspond to a distance between the linear portions 211/311 of the D-cut lens.

In an embodiment, the first lens 200 and the second lens 300 include a structure for mutual alignment.

In an embodiment, the lens barrel 100 may be configured such that a lens axis of the first lens 200 and a lens axis of the second lens 300 match. That is, when the first lens 200 and the second lens 300 are accommodated in the lens barrel 100, the two lenses 200 and 300 may be aligned with each other in a direction perpendicular to the optical axis O.

When a lens is axially symmetrical, only the lens axis needs to be aligned with the optical axis O, and even if the lens rotates about the optical axis O, there is no change in optical performance in relation to a adjacent lens. However, when a lens is non-axisymmetric, optical characteristics vary according to rotation of the lens, and thus a structure for preventing rotation of the lens is required.

In an embodiment, the lens assembly 10 may include a structure for aligning the first lens 200 and the second lens 300 in the circumferential direction (with respect to the optical axis O). For example, the lens assembly 10 may include a structure preventing rotation between the first lens 200 and the second lens 300, with respect to the optical axis O. Referring to FIG. 3, in an embodiment, the first lens 200 may include the protrusion 203, and the second lens 300 may include the recess 303 accommodating the protrusion 203.

When viewed in a direction parallel to the optical axis O, the protrusion 203 and the recess 303 are disposed at positions deviating from the optical axis O. Accordingly, when the first lens 200 is disposed on the second lens 300, mutual rotation of the first lens 200 and the second lens 300 may be prevented or minimized. Hereinafter, rotation of a lens refers to rotation with respect to the optical axis O.

In an embodiment, the protrusion 203 and the recess 303 may be disposed in positions that do not impair optical performance of the lens. In an embodiment, the first lens 200 may include an optical portion 201 exhibiting optical performance and a first flange surface 202 surrounding an outer circumference of the optical portion 201, and the protrusion 203 may be formed on the first flange surface 202. For example, the protrusion 203 may extend from the first flange surface 202 toward the second lens 300. For example, in the view illustrated in FIG. 3, the first flange surface 202 may be formed on a lower surface of the first lens 200.

In an embodiment, the second lens 300 may include an optical portion 301 exhibiting optical performance and a second flange surface 302 surrounding an outer circumference of the optical portion 301, and the recess 303 may be formed on the second flange surface 302. For example, the recess 303 may be a portion of the second flange surface 302 that is depressed with respect to an adjacent portion of the second flange surface 302. For example, in the view illustrated in FIG. 3, the second flange surface 302 may be formed on an upper surface of the second lens 300.

In an embodiment, a height h of the protrusion 203 and a depth d of the recess 303 may be within a range of greater than 0.03 mm and less than or equal to 0.2 mm.

In an embodiment, a plurality of protrusions 203 and recesses 303 may be arranged in a circumferential direction with respect to the optical axis O. In the illustrated embodiment, the protrusions 203 and the recesses 303 are provided in four pairs, but this configuration is only an example, and the protrusions 203 and the recesses 303 may be provided in one to three or pairs, or five or more pairs.

In an embodiment, the lens assembly 10 may further include a spacer 400 disposed between the first lens 200 and the second lens 300. Referring to FIGS. 3 and 4, the spacer 400 is mounted on the second lens 300, and the first lens 200 is mounted on the spacer 400. For example, the first flange surface 202 of the first lens 200 is in contact with one surface (e.g., an upper surface 401) of the spacer 400, and the second flange surface 302 of the second lens 300 is in contact with the other surface (e.g., a lower surface 402) of the spacer 400.

In an embodiment, a through portion 403 of the spacer 400 may be provided as a slot extending (e.g., extending by a greater amount) in one direction. The slot may be open in the one direction. In an embodiment, the through portion 403 may have a slot shape extending in the longer axis direction (i.e., the X direction) of the first lens 200. Referring to FIG. 3, the through portion 403 may have a slot shape extending in the X direction from a point at which the protrusion 203 is positioned to an outer circumferential surface of the spacer 400. The shape of the through portion 403 may have any shape, as long as the through portion 403 can accommodate the protrusion 203, and this disclosure is not limited to the shape of the illustrated through portion 403.

In an embodiment, the protrusion 203 and the recess 303 are located at portions facing the spacer 400 in the optical axis direction. For example, the first flange surface 202 of the first lens 200 faces the upper surface 401 of the spacer 400, and the protrusion 203 is positioned on the first flange surface 202. The second flange surface 302 of the second lens 300 faces the lower surface 402 of the spacer 400, and the recess 303 is positioned on the second flange surface 302.

In an embodiment, the protrusion 203 and the recess 303 may be configured to be spaced apart from each other. For example, the protrusion 203 and the recess 303 are configured to be spaced apart from each other in a direction parallel to the optical axis O (i.e., the Z direction). For example, an air gap g1 in the direction of the optical axis O exists between a top surface 204 of the protrusion 203 and a bottom surface 304 of the recess 303. That is, no other structure exists in a space between the protrusion 203 and the recess 303 in the optical axis direction. For example, the depth d by which the recess 303 is depressed from the second flange surface 302 may be greater than a length obtained by subtracting a thickness t of the spacer 400 from the height h of the protrusion 203 protruding from the first flange surface 202 (i.e., d>h−t).

In an embodiment, the protrusion 203 and the recess 303 may be configured to be spaced apart in a direction perpendicular to the optical axis O. Referring to FIG. 4, for example, an air gap g2 in the longer axis direction (i.e., the X direction) of the first lens 200 may exist between the protrusion 203 and the recess 303. In another embodiment, an air gap in the shorter axis direction (i.e., Y direction) of the first lens 200 may exist between the protrusion 203 and the recess 303.

Referring to FIG. 5, in an embodiment, air gaps g4 and g5 in a radial direction r and/or a circumferential direction c with respect to the optical axis O may exist between the protrusion 203 and the recess 303. Hereinafter, the radial direction r and the circumferential direction c refer to a radial direction based on the optical axis O and a circumferential direction based on the optical axis O, respectively.

In an embodiment in which the air gap g5 exists in the circumferential direction c, relative rotation between the first lens 200 and the second lens 300 may be allowed to some extent. However, an allowable rotation angle may be set within a range in which optical performance of the optical system is not degraded. In this disclosure, the optical system includes at least the first lens 200 and the second lens 300.

In another embodiment, the air gap g5 in the circumferential direction c may not exist between the protrusion 203 and the recess 303 with respect to the optical axis O. That is, the protrusion 203 and the recess 303 may contact each other in the circumferential direction c based on the optical axis O. Without the air gap in the circumferential direction c, relative rotation between the first lens 200 and the second lens 300 may be tightly limited.

In an embodiment, the air gap g4 in the radial direction r exists between an outer circumferential surface 205 of the protrusion 203 and a wall surface 305 of the recess 303. That is, no other structure exists in the space in the radial direction r between the protrusion 203 and the recess 303.

Referring to FIG. 4, in an embodiment, an air gap g3 may exist between the protrusion 203 and the spacer 400 in a direction perpendicular to the optical axis O.

In an embodiment, the air gaps g1, g2, g3, g4, and g5 between the protrusion 203, the recess 303, and the spacer 400 may be within a range greater than 0 mm and less than or equal to 0.1 mm.

Since the centers of the first lens 200, the second lens 300, and the spacer 400 are aligned by the lens barrel 100, the air gaps g1, g2, g3, g4, and g5, as illustrated in FIG. 4 or FIG. 5, may be maintained between the lens 200, the second lens 300, and the spacer 400, even without a structure limiting relative movement in the radial direction.

In an embodiment, the lens assembly 10 may include an alignment structure for aligning the first lens 200 and the second lens 300 in the circumferential direction with respect to the optical axis O. In an embodiment, the alignment structure may be configured to allow relative movement between the first lens 200 and the second lens 300 in a direction perpendicular to the optical axis. When the first lens and the second lens is coupled as the protrusion 203 being received in the recess 303, the first lens may be allowed to move with respect to the second lens in a direction perpendicular to an optical axis.

For example, the alignment structure includes the protrusion 203 and the recess 303. Since the protrusion 203 and the recess 303 are spaced apart from each other in a direction perpendicular to the optical axis O, if there is no lens barrel, relative movement may be made between the first lens and the second lens in a direction perpendicular to the optical axis.

In the illustrated embodiment, the protrusion 203 is formed in the first lens 200, and the recess 303 is formed in the second lens 300, but this is only an example. However, in another embodiment, the protrusion 203 may be provided in the second lens 300 and the recess 303 may be provided in the first lens 200.

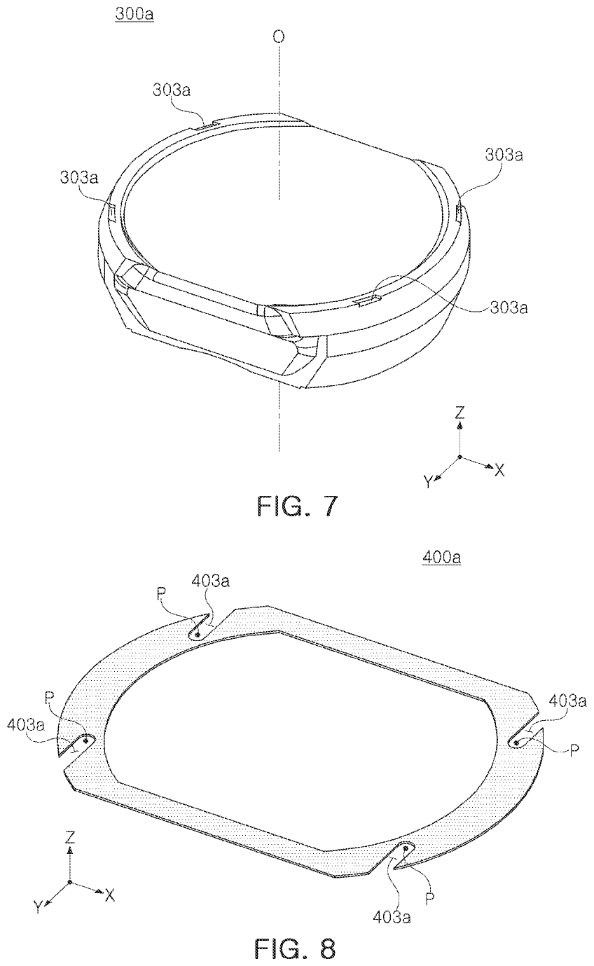

FIG. 6 illustrates another example of a protrusion 203a provided in a first lens 200a. FIG. 7 illustrates another example of a recess 303a provided in a second lens 300a. FIGS. 8 through 10 are examples of spacers according to embodiments.

Referring to FIG. 6, the protrusion 203a may have a semi-cylindrical shape. Referring to FIG. 7, the recess 303a may be provided in a form extending (e.g., extending by a greater amount) in a circumferential direction.

Referring to FIG. 8, in an embodiment, a through portion 403a of a spacer 400a may have a form of a slot extending in one direction. The slot may be open in the one direction. For example, the through portion 403a may be formed as a slot extending in the Y direction from a point P at which the protrusion 203a is located to an outer circumferential surface of the spacer 400a.

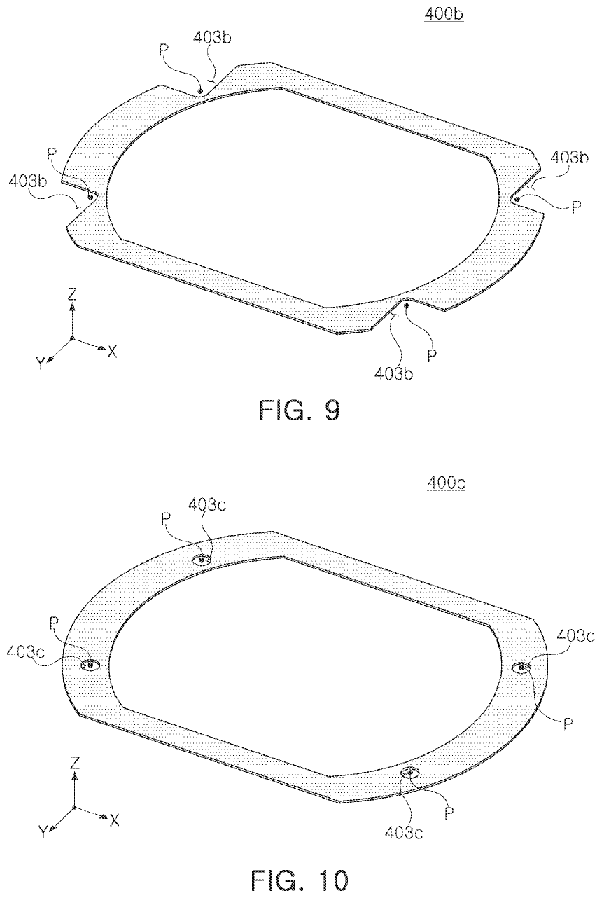

Referring to FIG. 9, a through portion 403b of a spacer 400b may have a form in which a portion of the spacer 400b is cut in an “L” shape. For example, a space between two edges extending in directions perpendicular to each other at a point P at which the protrusion 203 is located may be defined as the through portion 403b. Referring to FIG. 10, in an embodiment, a spacer 400c may be provided in the form of a hole.

The shapes of the protrusions and recesses shown in the drawings of the disclosure herein are only examples, and the disclosure is not limited to the examples described herein. In another embodiment, a protrusion (e.g., the protrusion 203) and a recess (e.g., the recess 303) may have various other shapes. That is, any configuration of a protrusion and a recess 303 may be employed as long as the configuration prevents relative rotation of the first lens 200 and the second lens 300, and the protrusion 203 and the recess 303 may be provided in various shapes in consideration of various factors such as ease of manufacturing or convenience of assembly.

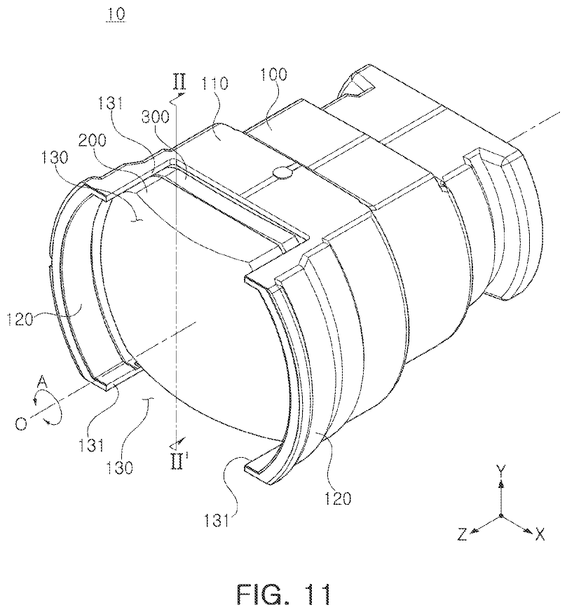

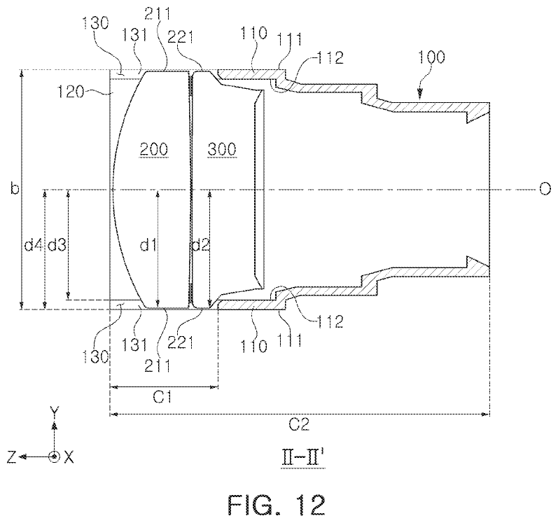

FIG. 11 is a perspective view of the lens assembly 10, according to an embodiment. FIG. 12 is a cross-sectional view taken along line II-II′ of FIG. 11.

Referring to FIG. 11, the lens barrel 100 is configured to surround at least a portion of the first lens 200. The lens barrel 100 surrounds the arc portion 212 of the first lens 200 in the circumferential direction. The arc portion 212 is surrounded by the lens barrel 100 and is not exposed externally of the lens barrel 100.

For example, the lens barrel 100 may include a flat plate portion 110 and a cylindrical portion 120. The flat plate portion 110 is disposed on both sides of the first lens 200. For example, the flat plate portion 110 may include two flat plates spaced from the optical axis O in a +Y direction and a −Y direction, and facing each other. The cylindrical portion 120 surrounds the arc portion 212 of the first lens 200 in a circumferential direction. The arc portion 212 is surrounded by the lens barrel 100 and is not exposed externally of the lens barrel 100.

In an embodiment, the linear portion 211 of the first lens 200 may be exposed externally of the lens barrel 100. That is, the lens barrel 100 is configured to not cover the linear portion 211 of the first lens 200. In an embodiment, the lens barrel 100 includes an open portion 130 corresponding to the linear portion 211 of the first lens 200, and the linear portion 211 may be exposed externally of the lens barrel 100 through the open portion 130. For example, when the linear portion 211 extends in the X direction perpendicular to the optical axis O, the linear portion 211 may be exposed in the Y direction through the open portion 130.

In an embodiment, the first lens 200 may extend to the open portion 130. That is, the linear portion 211 of the first lens 200 may be located inside the opening portion 130. For example, the lens barrel 100 may include an edge defining the open portion 130, and the D-cut lens may extend to a space surrounded by the edge. That is, a portion or the entirety of the linear portion 211 may be located in the space surrounded by the edge.

For example, referring to FIG. 12, a distance between the linear portion 211 of the first lens 200 and the optical axis O may be greater than a distance between the optical axis O and an inner surface of the flat plate portion 110. While a lens barrel of the related art covers all sides of the D-cut lens, in an embodiment, the lens barrel 100 exposes at least a portion of the linear portion 211 of the first lens 200, which is a D-cut lens. Without the open portion 130 in the flat portion 110 of the lens barrel 100, a shorter axis length of a D-cut lens is limited to an interval between flat plates disposed on both sides of the D-cut lens. In contrast, according to an embodiment, since the open portion 130 is provided in the flat plate 110, the first lens 200 may be manufactured such that a shorter axis length (i.e., 2*d1) is greater than an interval (2*d3) between the flat plate portions 110.

According to an embodiment, a length of the D-cut lens in the shorter axis direction may be longer than that of the related art, and an effective surface (i.e., the optical portion 201) exhibiting optical performance in the D-cut lens may be increased. This may contribute to improving optical performance of the D-cut lens or the lens assembly 10 employing the D-cut lens.

When viewed from the perspective of a thickness of the lens barrel 100, the effective surface of the D-cut lens may be increased without increasing the thickness of the lens barrel 100. This may contribute to thinning of the lens assembly 10 or a device employing the lens assembly 10. In addition, since the difference between the shorter axis length and the major axis length decreases, manufacturing of the D-cut lens is relatively easy. That is, the D-cut lens accommodated in the lens barrel 100 according to an embodiment may be manufactured to be is relatively closer to a prescribed design.

In an embodiment, the lens barrel 100 surrounds only the arc portion 212 of the first lens 200, without a structure suppressing rotation of the first lens 200 in the rotational direction A. However, the lens barrel 100 may partially or entirely surround the side surface of the second lens 300 to limit rotation of the second lens 300. In addition, since relative rotation of the first lens (e.g., the first lens 200) and the second lens (e.g., the second lens 300) is suppressed (or minimized) by the protrusion (e.g. the protrusion 203) and the recess (e.g., the recess 303), even if the open portion 130 is present, rotation of the first lens 200 with respect to the lens barrel 100 may be prevented or minimized.

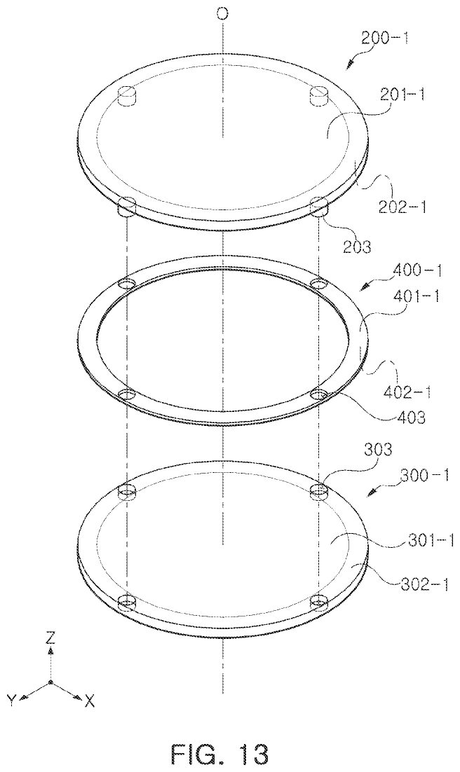

FIG. 13 shows an alignment structure between adjacent first and second circular lenses 200-1 and 300-1, in an embodiment. Descriptions of the protrusion 203 and the recess 303 are the same as those provided for FIGS. 1 to 10, and redundant descriptions thereof will be omitted below.

In an embodiment, the first lens 200-1 may non-axisymmetric with respect to the optical axis O, and may include an optical portion 201-1. The second lens 300-1 may include an optical portion 301-1.

In an embodiment, the first lens 200-1 may be a free-form lens. For example, a cross-section of the first lens 200-1 including the optical axis O and taken in a plane parallel to an X-Z plane and a cross-section of the first lens 200-1 including the optical axis O and taken in a plane parallel to a Y-Z plane may have different shapes.

In an embodiment, a lens assembly may include a structure preventing rotation with respect to the optical axis O between the first lens 200-1 and the second lens 300-1. In an embodiment, the first lens 200-1 may include the protrusion 203, and the second lens 300-1 may include the recess 303 accommodating the protrusion 203.

In an embodiment, the lens assembly may further include a spacer 400-1 disposed between the first lens 200-1 and the second lens 300-1. The spacer 400-1 is mounted on the second lens 300-1, and the first lens 200-1 is mounted on the spacer 400-1. For example, a first flange surface 202-1 of the first lens 200-1 is in contact with an upper surface 401-1 of the spacer 400-1, and a second flange surface 302-1 of the second lens 300-1 is in contact with a lower surface 402-1 of the spacer 400-1.

As set forth above, a lens assembly, according to embodiments, includes a structure for aligning a non-axisymmetric lens in a circumferential direction with respect to adjacent optical elements.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens assembly, comprising:
a first lens including a protrusion; and
a second lens disposed adjacent to the first lens and including a recess configured to accommodate at least a portion of the protrusion,
wherein the protrusion is spaced apart from the recess in an optical axis direction.

2. The lens assembly of claim 1, further comprising a lens barrel configured to align the first lens in a direction perpendicular to an optical axis with respect to the second lens, and
wherein the protrusion and the recess are configured to limit rotation of the first lens about the optical axis with respect to the second lens.

3. The lens assembly of claim 1, wherein the protrusion and the recess are spaced apart from each other in a direction perpendicular to the optical axis.

4. The lens assembly of claim 1, further comprising a spacer disposed between the first lens and the second lens.

5. The lens assembly of claim 4, wherein the protrusion and the recess are disposed in respective portions facing the spacer in the optical axis direction.

6. The lens assembly of claim 5, wherein the spacer includes a through portion configured to allow the protrusion to pass therethrough.

7. The lens assembly of claim 4, wherein the first lens includes a first optical portion exhibiting optical performance, and a first flange surface surrounding an outer circumference of the first optical portion and contacting the spacer, and
wherein the protrusion extends from the first flange surface toward the second lens.

8. The lens assembly of claim 7, wherein the second lens includes a second optical portion exhibiting optical performance and a second flange surface surrounding an outer circumference of the second optical portion and contacting the spacer, and
wherein the recess includes a depressed portion of the second flange surface.

9. The lens assembly of claim 8, wherein a depth by which the recess is depressed from the second flange surface is greater than a length obtained by subtracting a thickness of the spacer from a height at which the protrusion protrudes from the first flange surface.

10. The lens assembly of claim 1, wherein the first lens is non-axisymmetric with respect to an optical axis.

11. The lens assembly of claim 10, wherein the first lens is a D-cut lens.

12. The lens assembly of claim 11, further comprising:
a lens barrel accommodating the first lens and the second lens,
wherein the first lens includes a linear portion and an arc portion, and the lens barrel is configured to surround at least a portion of the arc portion and to expose the linear portion in a direction perpendicular to the optical axis.

13. The lens assembly of claim 12, wherein the lens barrel includes an open portion exposing the linear portion, the linear portion extends in a first direction perpendicular to the optical axis, and the open portion exposes the linear portion in a second direction perpendicular to both the optical axis and the first direction.

14. The lens assembly of claim 10, wherein the first lens is a free-form lens.

15. A lens assembly comprising:
a first lens;
a second lens adjacent to the first lens; and
an alignment structure aligning the first lens and the second lens in a circumferential direction with respect to an optical axis,
wherein the alignment structure is configured to allow the first lens to move with respect to the second lens in a direction perpendicular to an optical axis.

16. The lens assembly of claim 15, wherein the alignment structure includes a protrusion disposed on the first lens and a recess disposed in the second lens, and
wherein an air gap is disposed between the protrusion and the recess.

17. A lens assembly, comprising:
a first lens disposed on an optical axis;
one or more protrusions protruding from a surface of the first lens, in a direction parallel to the optical axis;
a second lens disposed on the optical axis; and
one or more recesses disposed on a surface of the second lens opposing the surface of the first lens in the direction parallel to the optical axis,
wherein the one or more protrusions extend only partially into the one or more recesses, respectively, in the direction parallel to the optical axis.

18. The lens assembly of claim 17, wherein the one or more protrusions are disposed on a flange of the first lens, and the one or more recesses are disposed on a flange of the second lens.

19. The lens assembly of claim 17, further comprising a spacer disposed between the first lens and the second lens in the direction parallel to the optical axis,
wherein the spacer includes one or more openings elongated in a direction perpendicular to the optical axis and configured to receive the one or more protrusions, respectively.

20. The lens assembly of claim 19, wherein each of the one or more protrusions is configured to be spaced apart from a wall defining a respective opening, among the one or more openings, in either one or both of a radial direction with respect to the optical axis and a circumferential direction with respect to the optical axis.
